(19) United States
(12) Patent Application Publication
(10) Pub. No.: US 2009/0165725 A1
(43) Pub. Date: Jul. 2, 2009

(54) METHOD FOR MILKING ANIMALS IN A GROUP

(75) Inventors: Peter Kaever, Oelde (DE); Matthias Ahrens, Lippetal (DE)

Correspondence Address: SEED INTELLECTUAL PROPERTY LAW GROUP PLLC, 701 FIFTH AVE, SUITE 5400, SEATTLE, WA, 98104, US

(73) Assignee: WESTFALIASURGE GMBH, Boenen (DE)

(21) Appl. No.: 11/916,444

(22) PCT Filed: Jun. 2, 2006
(86) PCT No.: PCT/EP06/05316

§ 371 Date: Dec. 8, 2008

(30) Foreign Application Priority Data
Jun. 2, 2005 (DE) 10 2005 025 467.5

(51) Int. Cl. A01J 5/007

(52) U.S. Cl. 119/14.02

(57) ABSTRACT

A method for milking animals in a group at a plurality of milking locations formed in a milking parlor, the method including the steps of manually applying, substantially successively, at each milking location a milking device to the udder of the animal to be milked and starting milking by a milking controller that controls the milking device. For adaptation to the individual needs of the milker, the present method suggests that a subsequent milking device of the milking parlor should be started in an automated manner in the order that corresponds to the order in which the milking device was attached and as a result of the starting of the preceding milking controller. The present method can be used for starting various milking phases, e.g. the automatic preparation phase for arranging the milking cups at a removal position for the user, or the milking phase in which milk is milked from the animal to be milked, in an automated manner on the basis of the respective time values previously required by a user for user-specific-phases.

### BACKGROUND

1. Technical Field

The present invention relates to a method for milking animals in a group at a plurality of milking locations formed in a milking parlor, said method comprising the steps of applying substantially successively at each milking location a milking device to the udder of the animal to be milked and starting milking by a milking controller which controls the milking device. All the methods in the case of which the animals of a group of animals to be milked are simultaneously present at the milking parlor can be considered to underlie the preamble of claim 1 of the present application. At the milking parlor a milking location is formed for each animal. Each milking location, i.e., each animal, has normally associated therewith a milking device which comprises a number of milking cups corresponding to the number of teats of the animal to be milked. The milking cups are applied to the teats of the animal to be milked.

The present invention especially relates to the application of the milking cups by hand, which is nowadays common practice in the case of small and medium-sized milking parlors. It should be differentiated between this manual application and the automatic application of the milking cups by a robotic milking machine. Each of the milking devices has associated therewith a milking controller which controls the milking of milk by pulsating pressure changes in a pulsation chamber of the milking cup and which, being a part of a herd management system, normally receives animal-specific information from the central memory and transmits animal-specific information, e.g., the amount of milked milk, to said memory during the milking process.

2. Description of the Related Art

In the case of the normally used systems, the user or users must, after having applied the milking cups to the teats, give a start signal for each milking location; this start signal will start the milking controller for the respective individual milking location. Said starting can, e.g., have the effect that, by activating the milking controller or milking controllers belonging to the respective milking devices, the pulsation of the milking cups is started. Likewise, starting can also mean that the automatic preparation phase begins, in which, by means of a movement of the unit holding the milking device, the milking device is moved to a position at which the milking cups are moved to a position that will allow the user to easily apply the milking device to the individual teats of the animal to be milked. At the end of this preparation phase, the milking cups are located at the position in question. The user, i.e., the milker, can easily take hold of the milking cups from this position and apply them manually to the udder of the animal to be milked.

A corresponding start signal can also be given for a group of milking locations. The milking controller will be started only after reception of the start signal at the milking controller. For triggering the start signal, a separate switch can be provided at the respective milking location, preferably on the display of the milking controller. Alternatively, the start signal can also be triggered by special handling of the milking device. For this purpose, suitable sensors are arranged either directly on the milking device or on the milking controller; said sensors detect, e.g., a specific position of the milking controller and generate the start signal in response thereto, or they detect, on the basis of special pressure conditions which are measured in the pulsation and/or milk draw-off conduits, the end of the application process and generate the start signal accordingly.

The operation of a separate switch by the user is time-consuming. In addition, attempts are made to reduce the device components of a milking parlor to the smallest possible number, since these components will have to be cleaned and perhaps even disinfected after each milking process. The above-mentioned sensors are interference-prone, they increase the costs for establishing the milking parlor, and they do not always guarantee a perfect detection of the actual situation. Misinterpretations of the actual situation at the milking parlor may occur especially due to the sensors; due to such misinterpretations, the milking controller will be started even though the milking cup application process has not yet taken place and/or has not yet been finished.

DE 102 57 735, which is owned by the applicant, discloses a method of the type in question in the case of which a substantially uniform milking period is centrally adjusted for at least some of the milking locations. This milking period can be started in a time-displaced manner for the plurality of milking locations. The method according to this prior art, e.g., specifies a period of time which has to be observed between the starting of temporally successive milking devices; the respective time period, which is fixedly predetermined by the control unit, can also take into account the time required for the manual application of the milking cups to the teats of the animal to be milked. The teaching according to DE 102 57 735 intends to optimize the time sequences for the milking processes at several milking locations, which are provided at a milking parlor, in such a way that the waiting time will be optimized for the animals to be milked. In particular, it is aimed at to combine the animals in clusters according to the milking time that has to be expected for them, so as to minimize the dwell time of the animals in the milking parlor. The working speed and the working conditions of the milker participating in this method must be subordinated to the needs of the animal to be milked.

### BRIEF SUMMARY

The present invention is based on the problem of providing a method in the case of which the working conditions of the milker are adapted in the best possible way to the personal needs and abilities of the milker and which allows fast and effective milking of the respective animals in a manner that is as precisely timed as possible.

For solving the above problem, the present invention suggests a method having the features of claim 1. This method differs from the generally known method insofar as at least one subsequent milking device of the milking parlor is started in an automated manner and as a result of the starting of the preceding milking controller.

In accordance with the method according to the present invention, the milking devices of different milking parlors are started successively in a temporal sequence. This is normally done by activating the milking controller or milking controllers belonging to the respective milking devices. Starting means here, e.g., that the vacuum and milk flow paths leading to the milking device are activated and also that the pulsation processes are started. These pulsation processes are started after the application of the respective milking device to the teats; normally, a user will successively apply in a temporal sequence different milking devices to the animals to be milked that are present at the milking parlor. The present invention is based on the finding that, due to the fixedly predetermined distances between the animals to be milked, these temporally successive applications of the milking devices will normally also take place at specific intervals. In the case of a routine work sequence, which will be accomplished after a familiarization phase of approx. 10 to 14 application processes, a normal user will require an almost constant period of time for moving, after having applied the milking cups at a milking location, from this milking location to the next one, for taking there hold of the milking device, for transferring it to the udder of the animal to be milked and for applying the milking device.

Hence, the method according to the present invention is so conceived that the second and each further milking device are started in an automated manner and after expiration of a predetermined time interval. This automatic starting of the milking devices is initiated by the starting of the preceding controller belonging to the first milking device of the time sequence. This preceding milking device can be the milking device which, at the beginning of the work cycle of a user, is the first milking device that is applied to an animal of the group which is to be milked. It is, however, just as well possible to wait until the above-mentioned familiarization phase has come to an end so as to determine, after the expiration of said familiarization phase, that a specific application of the milking device is the first application within the meaning of the present invention.

In accordance with the method according to the present invention, the second and each further milking device are started as a result of the starting of the preceding milking device. The starting of the preceding milking device determines not only the circumstance that the second and/or a further milking device is/are actually started but also the moment in time at which it is/they are started. The moment in time which is here considered to be relevant is in particular the start of pulsation to the preceding milking device. This moment in time represents the end of the manual application of the milking cups to the udder of the animal to be milked and, consequently, it also represents the time which, depending on the respective user, is required for manual application of the teat cups to the udder. It follows that, in the case of the method according to the present invention, also the personal disposition and the skill of the user are taken into consideration for determining the start of the subsequent milking device. The starting of the subsequent milking device can be considered to be, e.g., the start of the automatic preparation phase in the course of which the subsequent milking device is moved to a removal position for application to the udder. According to this special case management, the preparation phase is then started in dependence upon the starting of the preceding milking controller. Hence, the subsequent milking device is provided in dependence upon the termination of the application of a preceding milking device at the milking location.

A subsequent milking device within the meaning of the present invention can be considered to be a milking device which follows the preceding milking device in immediate temporal succession and which, in a temporal sequence, is applied to the next animal to be milked immediately after the application of the preceding milking device to the udder of an animal to be milked. The subsequent milking device may, however, also be a milking device which does not immediately follow the preceding milking device, but whose moment of application to the udder of a temporally subsequent, but not necessarily immediately subsequent animal is only a moment in time after the application of the preceding milking device.

By constantly monitoring the activities of the user, e.g., the user's operating steps at the milking parlor, and/or by monitoring the movements of the user, it will be possible to permanently estimate the user's working position and sequence of working steps. When the user takes time out—e.g., for fetching udder wipes—the control used in the method according to the present invention can rule out this idle time and proceed on the basis of the preceding estimated value for the application time. This will allow the user to immediately continue his work with his typical working speed after having fetched the upper wipes. Likewise, intervals caused, e.g., by exceptional circumstances such as milking devices that have been trodden off, can be recorded automatically and supplied to the control. Also this will allow the work to be continued immediately with the typical working speed of the user. Another feedback which is here provided, in addition to that in response to actuation by the user, is a feedback in response to process events, such as, e.g., the recorded flow of milk. Also this will allow a synchronization of the pre-controlled starting processes and of the actual working speed of the user.

In accordance with a preferred embodiment of the method according to the present invention, the time required for a preceding manual application of the milking device to the udder of an animal to be milked is ascertained and taken into account upon determining the starting of a temporally subsequent milking device to be applied. If the other phases of milking by means of automated processes take place in a fixed predetermined time frame, the user's dwell time at a specific milking location results from a possible waiting time, in the course of which the milker waits for the termination of the automatic preparation period, and from a manual phase, in which the milker applies the milking device to the udder of the animal to be milked.

For further optimizing the method and especially with respect to a reduction of the dwell time of the animals to be milked and of the milker at the milking parlor, it is suggested, in accordance with a further preferred embodiment of the present invention, that, prior to manual application, the milking device should be prepared at a milking parlor in an automated manner, and that the necessary preparation phase should be started in an automated manner in dependence upon the application time required at a preceding milking location. Process control is here preferably chosen such that in response to the arrival of a milker at the next milking parlor and with due regard to the known dwell time of the milker at a milking parlor, which may perhaps vary to a certain extent, the start of the preparation phase is determined and the preparation phase is started accordingly, so as to guarantee that the preparation phase will be terminated when the milker arrives at the next milking parlor, preferably that the preparation phase is just being terminated when the milker arrives at the next milking parlor. This has the effect that, when the automatic preparation phase has been terminated, the milking device will not be held at a stand-by position for an unnecessarily long period of time without being seized by the milker and applied to the udder of the animal to be milked. The milking device is therefore held exposed at the stand-by position for the shortest possible period of time without the milker having to wait for the provision of the milking device at the subsequent milking parlor.

It follows that the method according to the present invention allows the subsequent milking device to be started in a mode which is adapted to the time required for starting the preceding milking device. An aspect which will particularly be taken into account in this respect are time delays resulting from different application times for the application of the milking device to the udder of the animal to be milked, such different application times occurring when the milking devices are applied at the different milking locations, i.e., the adaptation is carried out on the basis of temporal sequences which have been learned directly in the course of the previous process. Hence, the method provides the possibility of automatically adapting to the milker's personal needs the preparation steps, which are necessary for a milking phase and which also include a manual activity of the milker. This applies to the automatic preparation phase as well as to the start of pulsation when the milking cups have successfully been attached to the udder of the animal to be milked. The process which are necessary prior to starting the milking phase, i.e., the transit phase in which the milker moves from the preceding milking location to the subsequent one, the automatic preparation phase and the manual phase for applying the milking device, are preferably ascertained with regard to their length of time by the central control unit of the milking parlor. In so doing, a signal transmitted in response to the starting of the preceding milking controller is used for time measurement. This signal specially indicates the end of the manual phase, i.e., the start of the milking phase.

As far as the above statements deal with a central control unit of the milking parlor, said central control unit can also be defined by the milking controllers which belong to the individual milking locations and which are interconnected by a logic. The milking controller can be prepared in various ways for indicating the end of the manual phase and the beginning of the milking phase, respectively. The milking controller can, e.g., determine the beginning and/or the initial characteristics of the flow of milk in the milking phase and can conclude therefrom whether the milking phase has begun. Likewise, the milking controller can monitor operating pressures, especially for pulsation at the milking device, and derive therefrom that the milking phase has begun. Alternatively, the position of the milking cups can be monitored and it can be concluded from a corresponding position signal that the milking phase has begun and the manual phase has been terminated. On the basis of the thus determined moment in time for the beginning of the milking phase, the temporal sequence resulting from the manual phase can be ascertained starting from the end of the automatic preparation phase.

This termination of the preparation phase can, e.g., be derived from a control signal for actuators which are active during the automatic preparation phase. In other words, the control signal for the actuators is used so as to detect the end of the automatic preparation phase. It is also possible to detect the end of the automatic preparation phase via the actuation of the milking device. It is imaginable that the milker will, when he arrives at the subsequent milking location, already take hold of the milking device before the automatic preparation period has come to an end. In this case, it will be concluded from the signal for the manual operation of the milking device at this milking location with still active actuators that the automatic preparation phase has been started too late, and, on the basis of adequate signal processing, the automatic preparation phase for the subsequent milking location will be started at an adequate earlier moment in time. It is also possible to detect time changes in the transit phase and to take them automatically into account for accomplishing a user-optimized provision and starting of the milking device at a milking location. In this connection, it is especially imaginable to measure, on the basis of the actuation of the milking devices at successive milking locations, the temporal length of the manual phase and/or the temporal length of the transit phase and to adapt, on the basis of these measurements, the time control of the automatic processes within the milking parlor to the respective speed of the milker in an optimized manner.

In the case of different milking parlors, the user or the users will have the possibility of varying the sequence of the milking devices to be started. For example, the users of a milking parlor having milking locations that are arranged in series can start the application from different ends of the elongate milking parlor essentially simultaneously. If the milking parlor in question is very long and comprises milking locations that are arranged one after the other in series, the application may also be started in the middle and continued along the individual milking locations either in the direction of the first or the second end of the elongate channel (milking pit). With respect to the above, a further preferred embodiment of the present invention suggests that the sequence of the milking devices which are to be started successively should be determined by a sequence signal generated by the user. The sequence signal makes known to a central control belonging to the milking controller or milking controllers which milking device will be the second milking device when the first one has been started.

According to an alternative embodiment, the sequence signal can be ascertained in an automated manner by ascertaining signals from two milking devices which have been started in immediate succession. On the basis of these two signals it can be discerned how the sequence of the milking devices which are to be started successively has taken place according to the user's choice. Taking as a basis this sequence of two successive milking devices, conclusions can be drawn with regard to the rest of the sequence on the basis of empirical values or stored values. Furthermore, it is possible to discern various application sequences in parallel so as to support a plurality of users. Also the recognition of a successively executed application process can be used as an important feedback on the actual working speed of the users. This can be accomplished by measuring the flows of milk or by the use of other sensors, such as kickoff sensors or milk-flow and temperature sensors.

As has already been mentioned hereinbefore, the next milking device is started in the temporal sequence after the termination of a time interval. This time interval starts running preferably upon application of the preceding milking device. The starting point of the interval may, e.g., be the application of the first milking cup to one of the teats of the animal to be milked. Alternatively, also the removal of the whole milking device from an idle position at the milking parlor can define the temporal starting point of the time interval. According to still another alternative, the above-mentioned time interval may begin upon activation of the milking controller of the previously applied milking device. Another possibility of determining moments of starting is the detection of the moments in time at which the flow of milk starts or exceeds a threshold value. Another determination may refer to the stabilization of the vacuum level on the teat or in the milk collecting piece.

For taking into account user-specific working speeds, respective speed profiles for individual users or groups of users (beginners, advanced milkers, expert milkers) are stored according to a preferred embodiment. These speed profiles preferably determine the lengths of the time intervals between successive application processes. These time intervals can be stored itemized according to phases; a respective profile can be stored for each phase depending on the milker's working speed and speed of movement. These profiles can be read in for each individual user and they can be adjusted by the respective user when he starts working. This means that preset values are first ascertained which, in the course of the milker's subsequent work, will be overwritten by the time intervals which actually elapsed between successive application operations; this is done preferably phasewise, i.e., the duration of the transit phase and/or the duration of the manual phase are ascertained and transformed and stored for the purpose of controlling the next milking parlor in the sequence of operating steps. The familiarization phase can be accounted for by providing first time intervals which are comparatively long and which may vary, if necessary, and by predetermining constant, shorter time intervals when the familiarization phase has terminated. Furthermore, it is also possible to store a learning progress that can be expected from an unskilled user so that longer time intervals will first be predetermined beyond the normal familiarization phase, said longer time intervals being then reduced later on, i.e., for application processes carried out later on. This comparatively late application process need not necessarily be an application process carried out in the case of the first group after starting the milking of the animals to be milked, but this application process may take place in the case of the second or even further groups of animals to be milked. The term group stands for the number of animals which are present, essentially simultaneously, in the milking parlor for milking. Furthermore, a learning curve, i.e., the actual required periods of time for manual application, can be ascertained and written into a memory, preferably a memory of the herd management system; this memory can be associated with the user or the group of users.

In order to improve the method, a preferred further development provides possibilities of interrupting or stopping the automated process sequences. These possibilities are specified in detail in claims 14 to 18 and allow special treatments of, e.g., animals or devices, if this should become necessary in the course of the milking operation. For example, the user(s) of the device can generate a stop signal making use of a user-operated switch; this will have the effect that the starting of a milking device is delayed due to the stop signal. This delay may be a permanent delay, which will only be eliminated when the switch is operated by the user once more. Likewise, a stop signal which is generated once can have the effect that the process is started again, when a delay interval has elapsed. The delay interval only leads to an interruption of the process for a predetermined period of time, if an additional period of time having approximately the same length should be required, e.g., for a special treatment of a group of animals to be milked. Alternatively, the stop signal can be generated in an automated manner on the basis of information stored in the herd management system. This information is in particular animal-specific information. It causes, e.g., a delay of the starting of the milking device associated with a milking location at which a specific animal which is to be milked and for which a special treatment is stored in the herd management system is present. The starting of the milking device belonging to this specific milking location is delayed as long as this special treatment is carried out. An exceptional situation is, e.g., the direct-to-can milking, i.e., the milking of milk into a separate can instead of the central milk tank; this exceptional situation can be taken into account in the sequence of method steps manually or by a stop signal generated in an automated manner, preferably on the basis of a signal which is automatically generated and transmitted by the herd management system.

Process control by the milking controller can preferably be executed such that, when the milking cups have been applied to the teats of the animal to be milked, a stimulation phase will first be initiated. In addition, this stimulation phase can be preceded by a period of rest according to a further preferred embodiment of the present invention. In this case, no pulsation will take place in the period of rest after the application of the milking device, and the milking cups are just held dangling from the udder. Subsequently the stimulation phase is initiated, and then the actual milking phase begins.

With regard to a comprehensive acquisition of data, the milking phase should not be started until an acknowledgement signal, which acknowledges the operability of a herd management program, has been received by the milking controller. What is here specially acknowledged is the recording of animal recognition of an animal to be milked at the stall so that the animal-specific yield values and perhaps also fodder values for feeding at the milking location can be acquired correctly. This acknowledgement signal can be supplied automatically, if a signal which indicates a malfunction and which has to be manually generated by the user, does not occur, so that, in the trouble-free normal case, interaction between the user and the control will not be necessary. For a more effective supervision of trouble-free operation, the user preferably receives acoustic and/or optic signals from the milking controller and, if such signals fail to appear, he can intervene manually.

In cases in which the method is executed at a rotary milking parlor, an adaptation of the rotary speed of this rotary milking parlor to the sequence of time intervals proved to be expedient. The application of the milking device is therefore always carried out at a predetermined position on the circumference of the rotary milking parlor at which the user can abide and at which the necessary operating elements and facility parts can be arranged within easy reach of the user. Finally, the time interval can also be influenced in an animal-specific manner, so as to take into account, e.g., the behavior of the animal in question during the application of the milking device. It may, for example, happen that young animals resist application of the milking device, and this will result in a delay of the application process. Such an animal can be identified in time by the animal identification device which is normally provided at a milking parlor and the predetermined time interval can be extended by a correction value. In addition, such an extension can be indicated by the above-mentioned acoustic and/or optical indicator means.

Other preferred embodiments of the present invention are disclosed in the subclaims.

### BRIEF DESCRIPTION OF THE SEVERAL VIEWS OF THE DRAWINGS

The considerations underlying the present invention are illustrated by the diagrams shown in the drawings, in which

FIG. 1 shows the sequence of working steps in a group milking parlor in the case of an embodiment of a method according to the present invention;

FIG. 2 shows the application frequency according to FIG. 1 in the case of a conventional sequence of method steps;

FIG. 3 shows the typical application period in a group milking parlor in dependence upon the number of application processes.

### DETAILED DESCRIPTION

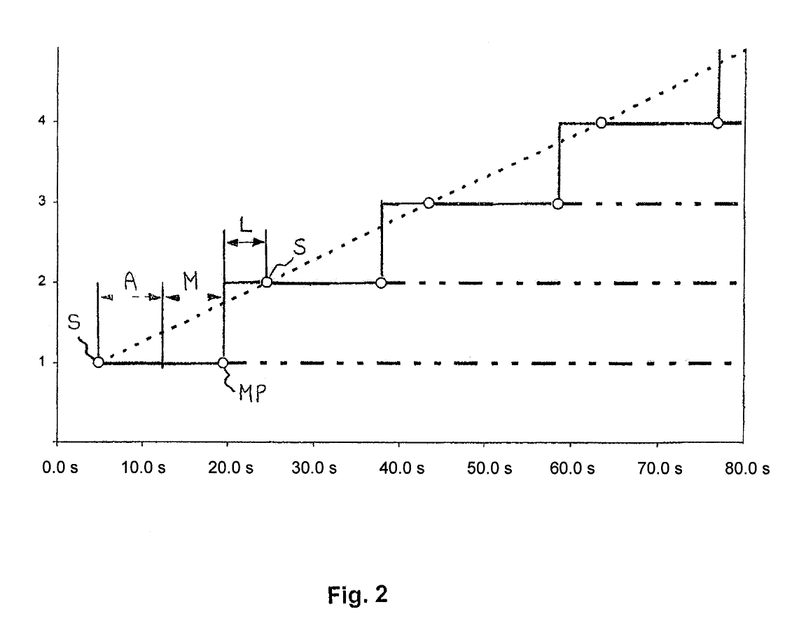

FIG. 2 shows schematically the typical sequence of working steps in a group milking parlor, e.g., in a tandem milking parlor. The time is plotted along the abscissa, and the number of milking locations at which the milking cups are successively applied is plotted along the ordinate. At the starting point S, the user manually generates a start signal at the milking controller of the first milking location. This has the effect that a few preparations are made at the milking controller and the milking device, said preparations being controlled automatically by the milking controller. The milking device is lowered. Pulsation starts and the milking device is automatically pre-positioned. The milk flow paths of the milking device are activated (automatic preparation phase A). Subsequently, the user takes hold of the individual milking cups and applies them sequentially to the teats of the animal to be milked (manual phase M). When all the milking cups have been applied, the milking process (MP) will start. The user will then move to the second milking parlor. The transit and preparation time required for this purpose is identified as L-phase. Upon reaching the second milking parlor, the user will trigger another start signal S. This is followed by a waiting period for the user in which the above-mentioned automated phase A is executed. Following this, an activity will be demanded from the user, i.e., the individual milking cups will have to be applied to the teats. This process is repeated at each milking parlor.

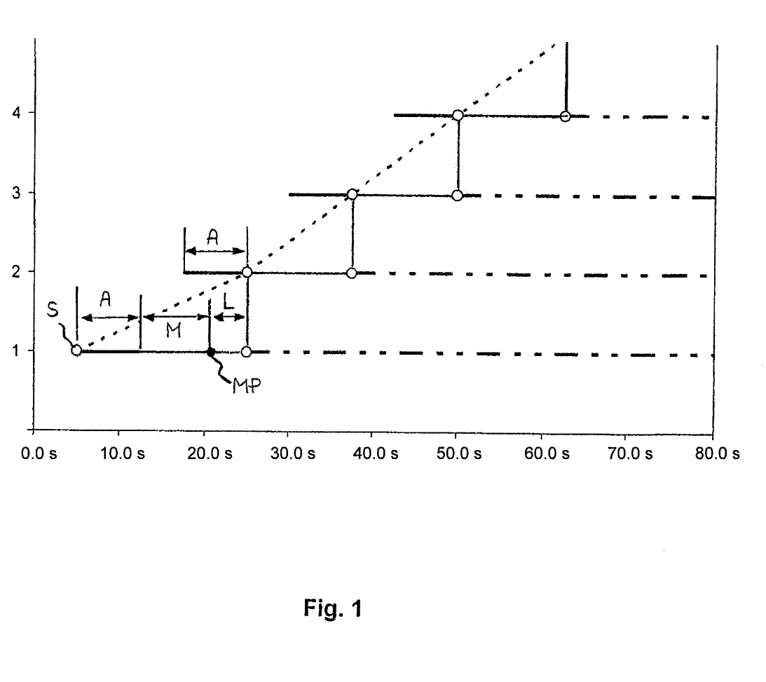

FIG. 1 exemplarily illustrates the sequence of operations taking place when the method according to the present invention is executed. Also in this case, the automated phase A is first started by pressing the start button S at the first milking parlor. Subsequently, the manual activity of the user begins (M). When all the milking cups have been attached, the milking phase will start (at MP). During the application movements performed at the first milking parlor, the automated phase A will already be started at the second milking parlor. This automatic activity at the second milking parlor has been initiated by pressing the start button S at the first milking parlor. The time which then elapsed is stored as a time interval in a memory and begins to run automatically when the start signal has been received. After having applied all the milking cups at the first milking parlor, the user needs the transit time L for reaching the second milking parlor, where he will preferably arrive precisely at the moment at which the automated phase A has come to an end. He can then immediately start to apply the milking cups to the teats. This process is repeated at the third and at each further milking location. It follows that, after having arrived at the milking location in question, the user no longer has to wait for an automatic provision of the milking device for preparing manual application to the teats.

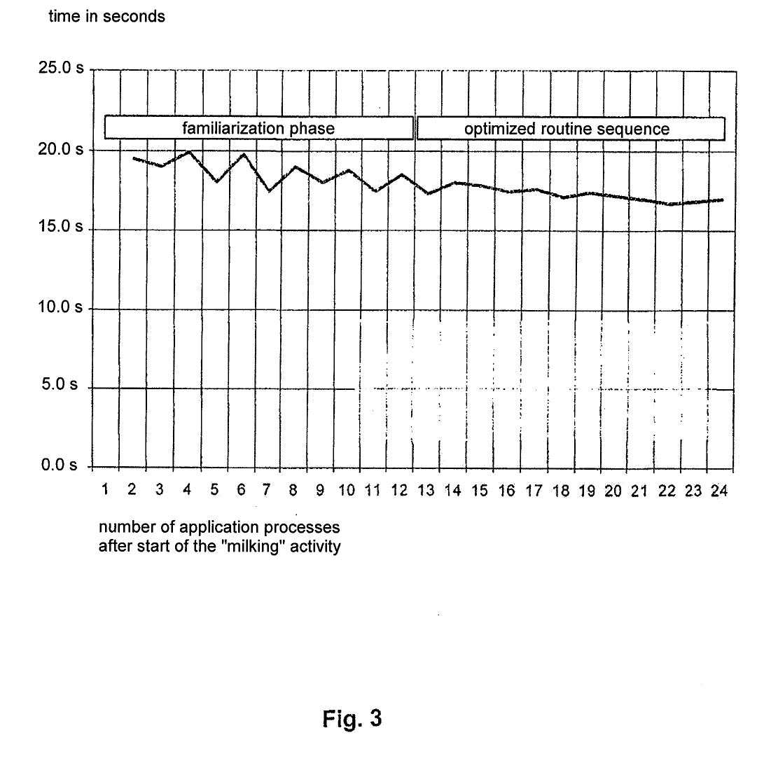

The above-mentioned time intervals can be adapted in a flexible manner, either each time interval separately or all the time intervals in a uniform manner. In particular findings on the familiarization period, which are shown in FIG. 3, provide guidance in this respect. Practical experiments have shown that trained users will also require different periods of time for applying the milking cups, when they carry out the first to approximately twelfth application after starting work. In this familiarization period, a longer time interval can be chosen so as to provide, in any case, sufficient time for the longest milking cup application period within the given variations and so as to allow easy familiarization conditions for the user. When this familiarization phase has come to an end (approx. after 10 to 15 application operations), the average user will invariably need approx. 12.5 seconds for the manual phase M. The total time plotted along the ordinate is composed of the two phases for automatically preparing the milking device A, the so-called machine preparatory work of 5 seconds, and the manual phase M for applying the individual milking cups to the teats.

The correlation shown in FIG. 3 can be stored for specific users or groups of users. Especially in the case of untrained users, a longer familiarization phase can, e.g., be chosen, i.e., the intervals will remain comparatively long, e.g., up to the twentieth application after start of work, until an untrained user gets a feeling of increased surehandedness for the activities in which he still needs practice and gets quicker. In addition, the time required by a user for phase M can be monitored, and the actual values ascertained and measured for this phase M within the framework of this monitoring can be taken into account in the determination of the time interval for the next application. Likewise, it is also possible to reduce, in the case of experienced users, the familiarization phase and/or to reduce the manual activity phase A in the familiarization phase or, in any case, in the routine phase. The method according to the present invention provides the possibility of eliminating essentially any waiting period of the user between the moment at which he reaches the milking location and the moment at which he will apply the milking device to the udder of the animal to be milked.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for milking animals in a group at a plurality of milking locations formed in a milking parlor, the method comprising the steps of: manually applying substantially successively at each milking location a milking device to the udder of the animal to be milked, starting the milking device with a milking controller that controls the milking device, and starting a subsequent milking device of the milking parlor in an automated manner as a result of the starting of at least one preceding milking device, and as a result of an application phase required for a preceding manual application of the milking device to the udder of the animal to be milked.

2. (canceled)

3. The method of claim 1, comprising, prior to manual application, preparing the milking device in an automated manner in dependence upon the application time required at a preceding milking.

4. The method of claim 1, wherein the successive sequence of starting the milking devices is determined by a sequence signal generated in response to user input.

5. The method of claim 1, wherein the successive sequence of starting the milking devices is determined by signals generated in response to the use of a milking device and coming from two milking devices that have been started in immediate succession.

6. The method of claim 1, wherein a next milking device is started after the end of a time interval that has started running upon application of a preceding milking device.

7. The method claim 5, wherein the time interval starts running when the milking controller of the preceding milking device is activated.

8. The method claim 5, wherein the time interval starts running after the discontinuance or after the beginning of the flow of milk at one of the previously applied milking locations.

9. The method of claim 1, wherein the application phases following one another in succession are determined in an automated manner on the basis of a user-specific speed profile and are used for controlling a subsequent milking.

10. The method of claim 8, wherein, after application of the milking device, a milking phase will not be started until an acknowledgement signal, which acknowledges the operability of a herd management program, has been received by the milking controller.

11. The method claim 8, wherein individual automated phases controlled by the milking controller are indicated by at least one of acoustic and optic signals.

12. The method of claim 1 in a rotary milking parlor, wherein a rotary speed of the rotary milking parlor is adapted to a time interval of the starting sequence.

13. The method of claim 1, comprising starting a preparation phase, which is to be executed in an automated manner, at at a next milking location when a milking phase has not yet begun at a preceding milking location.

14. The method of claim 1, comprising delaying the starting of a milking device due to a stop signal.

15. The method claim 14, comprising generating the stop signal with a user-operated switch.

16. The method claim 15, comprising discontinuing the process in response to occurrence of a stop signal and not restarting until another signal is supplied from the switch.

17. The method of claim 16, comprising discontinuing the process for a predetermined delay interval in response to the stop signal.

18. The method of claim 14, comprising generating the stop signal in an automated manner on the basis of information stored in a herd management system and concerning the animal at the milking location associated with the milking device that is started with delay.
